(19) United States
(12) Patent Application Publication
(10) Pub. No.: US 2021/0301979 A1
(43) Pub. Date: Sep. 30, 2021

(54) MOBILE LIQUEFACTION PLANT FOR LIQUEFYING HELIUM, ASSOCIATED SYSTEM, AND ASSOCIATED USE OF THE SYSTEM

(71) Applicant: Bruker Switzerland AG, Faellanden (CH)

(72) Inventor: Patrick Wikus, Nuerensdorf (CH)

(21) Appl. No.: 17/218,311

(22) Filed: Mar. 31, 2021

(30) Foreign Application Priority Data
Mar. 31, 2020 (DE) 10 2020 204 186.5

(51) Int. Cl. F17C 5/04; F25J 1/00; F17C 5/06; F17C 13/00; F17C 13/08

(52) U.S. Cl. CPC F17C 5/04; F17C 2270/0171; F17C 5/06; F17C 13/006; F17C 13/084; F25J 2290/70; F17C 2223/0123; F17C 2225/0161; F17C 2250/01; F17C 2260/02; F17C 2260/03; F17C 2265/015; F17C 2265/033; F17C 2270/0134; F25J 1/0007

(57) ABSTRACT

A mobile liquefaction plant (7) for liquefying helium, includes
a liquefaction device (8) that liquefies helium,
an intermediate storage tank (9) for liquefied helium,
a cleaning device (29) which removes non-helium components from the helium and is connected upstream of the liquefaction device, and
an additional collecting device (25) that collects gaseous helium which evaporates when an application cryostat (4) is filled with liquid helium and that includes a container (26) with a flexible wall and which stores the collected gaseous helium approximately at atmospheric pressure. The container (26) has an available container volume of at least 5 m³. Systems provided with such a mobile liquefaction plant exhibit an improved recovery of helium from application cryostats in a simple and cost-effective manner.

### CROSS REFERENCE TO RELATED APPLICATIONS

This application claims foreign priority under 35 U.S.C. § 119(a)-(d) to German Patent Application 10 2020 204 186.5 filed on Mar. 31, 2020, and the contents of which are incorporated into the present application by reference in their entirety.

### FIELD OF THE INVENTION

The invention relates to a mobile liquefaction plant for liquefying helium, comprising

a liquefaction device for liquefying helium,

an intermediate storage tank for liquefied helium, and

a cleaning device for helium which removes non-helium components from the helium by freezing out and/or sorption at a cryogenic temperature of ≤100 K and is connected upstream of the liquefaction device.

### BACKGROUND

Such a mobile liquefaction plant is known from the Internet publication “Liquid Helium Plants and Helium Recovery Systems” by Cryomech, Syracuse, N.Y., US, cf. https://www.cryomech.com/liquid-helium-plants/downloaded on Mar. 24, 2020.

Liquid helium is required in many low-temperature applications, in particular for cooling superconducting magnets. Helium is obtained as a by-product in natural gas production or from helium-rich gas sources (“helium sources”). Although helium is also present as a trace element in the atmosphere, it cannot be extracted economically from the atmosphere. Accordingly, helium is a limited resource.

The availability of helium on the world market is decreasing. It is expected that this trend will continue in the future, cf. Halperin, W. The impact of helium shortages on basic research. Nature Phys 10, 467-470 (2014), https://doi.org/10.1038/nphys3018. The helium prices are rising, which makes the operation of devices that require helium more expensive. Helium supply bottlenecks can even result in devices that require helium to need to be shut down.

In many applications, helium is used in an “open circuit,” in which helium is delivered to a consumer in liquid form, where it is used, for example, for cooling a magnet, and evaporates into the atmosphere. This approach greatly contributes to the shortage of helium.

Many consumers have therefore invested in helium recovery, in which the evaporated helium is collected, for example, in a balloon, and compressed by a compressor in a high-pressure storage tank. These high-pressure storage tanks can then be transported to a liquefaction plant operated by an external service provider, where the helium is liquefied and the liquefied helium is delivered back to the consumer. It must be noted that the liquid helium usually boils during transport, which means that, depending on the distance, a significant quantity of the liquid helium is lost during transport. In addition, the transport of larger quantities of helium (be it in liquid form or in a high-pressure storage tank) is complex and also dangerous. In many regions of the world, there is no external service provider that is located sufficiently close to the consumer to render such a procedure feasible.

Some consumers combine their helium recovery plants with a stationary local helium liquefier. For large consumers (e.g., a university), liquefiers according to Claude's process that have good thermodynamic efficiency (usually around 1 kW/(l/h) or even less) with a high liquefier capacity (about 30 l/h and more) can be used. However, the plants are very expensive and, due to their large capacity, can only be operated economically by large-scale helium consumers. Corresponding plants are offered, for example, by AirLiquide under the name “HELIAL Helium Liquefiers”, cf. https://advancedtech.airliquide.com/helial-helium-liquefiers downloaded on Mar. 24, 2020.

For smaller consumers, helium liquefiers come into consideration in which helium is liquefied using a cryocooler (such as a pulse tube cooler). The liquefaction capacity is usually around 0.5-3.5 l/h although the thermodynamic efficiency is significantly less good and usually lies around 5-15 kW/(l/h). Cryomech offers corresponding liquefaction plants with a pulse tube cooler, cf. the Internet publication “Liquid Helium Plants and Helium Recovery Systems” by Cryomech mentioned at the outset. Similar liquefaction plants with a GM cooler are known from the Internet publication “Advanced Technology Liquefiers” by Quantum Design, Darmstadt, Del., cf. https://qd-europe.com/de/de/produkt/kryotechnologie/heliumverfluessiger/helium-verfluessiger-advanced-technology-liquefier downloaded on Mar. 24, 2020. The liquefaction plants by Quantum Design are also described in the company publication “ATL Take Control of your Helium Supply,” cf. http://qd-europe.com/fileadmin/Mediapool/prxducts/atl/pdf/ATL.pdf downloaded on Mar. 9, 2020.

The typical helium consumption of individual application cryostats, such as the cryostat of an NMR magnet, is approximately 0.013-0.05 l (liquid)/h during normal operation. Therefore, even the helium liquefiers designed for smaller consumers are significantly oversized, which does not make these helium liquefiers very profitable for small consumers.

For example, from the above-mentioned Internet publication “Liquid Helium Plants and Helium Recovery Systems” by Cryomech or the Internet publication “Advanced Technology Liquefiers” by Quantum Design, cf. https://qd-europe.com/fileadmin/Mediapool/products/atl/pdf/ATL_for_NMR.pdf downloaded on Mar. 9, 2020, it is known to collect evaporating helium from an application cryostat using a local collecting device, compress it with a compressor and store it in a compressed gas storage tank. For this purpose, a balloon storage device can be used, with which the vaporized gaseous helium is temporarily stored (buffered) essentially at atmospheric pressure. Then, as soon as a certain quantity of helium gas has accumulated, the compressor is activated and the helium is compressed into the compressed gas storage tank (usually a high-pressure compressed gas storage tank); in this case, even when the application cryostat is filled with liquid helium, evaporating gaseous helium can be collected, provided that the balloon storage device is sufficiently large. However, it is also possible to convey the collected evaporated helium using a compressor in continuous operation into a compressed gas storage tank (usually a medium-pressure storage tank). In this case, when the application cryostat is filled with liquid helium, only a small portion of the evaporating gaseous helium can be collected at best. The helium stored in the compressed gas storage tank is occasionally liquefied using a helium liquefier and filled back into the application cryostat; for this purpose, a cleaning device is connected upstream. In order to transfer the liquid helium in the laboratory building from the compressed gas storage tank to the application cryostat, the helium liquefier is arranged on rollers. In the design of the Internet publication “Liquid Helium Plants and Helium Recovery Systems” by Cryomech, the cleaning device is also arranged on rollers.

A local, large balloon storage device is an expensive purchase and also requires much space in the laboratory building. If no balloon storage device is used, a great quantity of helium is lost into the atmosphere when liquid helium is replenished.

It is also known to integrate a cryocooler directly into an application cryostat in order to minimize helium consumption. However, this is not thermodynamically efficient (at approximately 30 kW/(l/h) or even more).

US 2013/0 291 585 A1 describes a stationary plant for liquefying helium.

From GB 1 064 834 A, a collecting device for gaseous helium with an elastic bladder, a compressor and gas cylinders on a common, mobile frame is known.

CN 201338724 Y describes a device for mobile helium supply, for example, for an airship, which can be arranged on a truck, with a compressor, a dryer and a pressure storage tank for helium.

US 2006/0156742 A1 describes a method and a device for providing a cryogenic fluid. The cryogenic fluid is transported in a liquid state and can be made available in liquid or gaseous form. The device can be transported by truck.

EP 0 520 937 A1 and US 2009/0 199 579 A describe cooling stations for mobile helium tanks.

### SUMMARY

One object addressed by the invention is that of improving the recovery of helium from application cryostats in a simple and cost-effective manner.

According to one formulation of the invention, this object is addressed by a mobile liquefaction plant of the type described at the outset which is characterized in that: the mobile liquefaction plant further comprises

an additional collecting device for collecting gaseous helium which evaporates when an application cryostat is filled with liquid helium,

the additional collecting device comprising a container with a flexible wall in which the collected gaseous helium can be stored approximately at atmospheric pressure,

and the container with a flexible wall having an available container volume VOLB of at least 5 m³, preferably at least 7.5 m³, particularly preferably at least 10 m³, very particularly preferably at least 15 m³.

Within the scope of the invention, a mobile liquefaction plant comprises the liquefaction device for liquefying gaseous helium, the intermediate storage tank (e.g., a Dewar) for liquefied helium, the cleaning device for helium, and the additional collecting device, with which evaporating gaseous gas can be collected when liquid helium is replenished. The mobile liquefaction plant according to the invention thus combines the components which are only required briefly during the regeneration of the local application plant, i.e., when locally stored helium (collected during normal operation) is liquefied and when the local application cryostat(s) are refilled with the liquefied helium. Accordingly, these components subsequently do not have to be made available locally at the application site by each local stationary application plant. As a result, the local application plant becomes simpler and more cost-effective, and requires less space. The local application plant must only be designed to collect and store the gaseous helium which evaporates during normal operation, which is relatively easy because usually only small quantities of helium (mostly 0.05 l (liquid)/h or less per application cryostat) evaporate during normal operation. The mobile liquefaction plant can be used successively at different stationary application plants, resulting in a good utilization of the mobile liquefaction plant. By contrast, it would usually only be possible to utilize the associated components to a small extent if they were acquired locally at (each) application plant.

The mobile liquefaction plant is preferably manageable and transportable in its entirety; alternatively, it is also possible to assemble the mobile liquefaction plant at each application site from a plurality of individually transportable components. It has connections for a temporary connection to a local source of gaseous or supercritical helium (e.g., a compressed gas storage tank of a local application plant, see below), and also connections for a temporary connection to a local application cryostat in order to fill this application cryostat with liquid helium and to collect evaporating, gaseous helium (in larger quantities) during filling.

The intermediate storage tank can be integrated into the liquefaction device, or (preferably) formed separately from the liquefaction device. In addition to the intermediate storage tank, the mobile liquefaction plant can have an auxiliary storage tank for liquid helium, in particular the auxiliary storage tank being integrated into the liquefaction device and the intermediate storage tank being formed separately from the liquefaction device. The intermediate storage tank and optionally the auxiliary storage tank are typically designed as vacuum-insulated containers (Dewar).

The mobile liquefaction plant can have its own power supply for operating the cleaning device and the liquefaction device, for example, a fuel-operated generator. Irrespectively, the mobile liquefaction plant is preferably also designed for operation with an external power source. In particular, the mobile application plant can be supplied with electrical power from an on-board network of a truck or motor vehicle by which the mobile application plant is transported.

The mobile liquefaction plant can comprise one or more measuring apparatuses for determining the purity of helium, the measuring apparatus(es) preferably being installed in front of the cleaning device and/or between the cleaning device and the liquefaction device. With one measuring apparatus in front of and behind the cleaning device, the function of this cleaning device can be monitored.

The mobile liquefaction plant basically has its own liquefier compressor with which the liquefaction device is operated. The liquefier compressor is preferably air-cooled, but can also be water-cooled. The liquefier device can comprise a cryocooler, for example, a GM cooler or a pulse tube cooler, the working gas of which is compressed by the liquefier compressor. Alternatively, the liquefier compressor can also be designed to compress the helium to be liquefied in order to allow it to do work on a piston engine or a turbine, and subsequently expand it on a Joule-Thomson valve.

The container with a flexible wall (“flexible container”) of the mobile liquefaction plant can in particular be designed as a so-called balloon storage device. The pressure in the flexible container is typically a maximum of 1.2 bar, usually a maximum of 1.1 bar; generally, the pressure in the flexible container lies between 0.9 and 1.2 bar. Evaporating helium from the application cryostat flows directly into the container (without the interposition of a compressor) and unfolds it during filling. The flexible container, e.g. its wall, can be weighted using one or more weights (such as a grid) in order to give the unfolding of the container a preferred direction; the weighting slightly increases the pressure in the flexible container.

### FURTHER EXEMPLARY EMBODIMENTS OF THE MOBILE PLANT

In a preferred embodiment of the mobile liquefaction plant according to the invention, the mobile liquefaction plant further comprises

a temperature control device for heating gaseous helium evaporating from an application cryostat to at least 10° C., preferably to room temperature,

the temperature control device being transportable separately from the remainder of the mobile liquefaction plant, and

a transfer line for transferring heated gaseous helium from the temperature control device to the additional collecting device. The temperature control device is set up in the immediate vicinity of the application cryostat and connected to it. The heating of the evaporated helium by the temperature control device prevents the formation of condensation or ice on the outside of the transfer line, and thus prevents undesirable (especially accident-prone) puddles from forming along the transfer line which is often guided over long distances in buildings at the application site. The transfer line can be designed as a lay-flat hose. Lay-flat hoses require little space for storage (which is important for a mobile unit) and, despite the small storage space requirement, can be designed with large cross-sections (which is important for keeping the pressure drop between the application cryostat and the flexible container in the mobile liquefaction plant at a minimum).

In a preferred development of this embodiment, the temperature control device is designed as a water tank through which a tube coil, through which the gaseous helium to be heated can be conducted, is guided. This design of the temperature control device is cost-effective and simple. The heat capacity of the water tank or the water contained therein (which is typically at room temperature) can easily absorb the coldness of the evaporated helium without cooling down noticeably. The water tank typically has a volume of at least 50 liters, usually at least 100 liters.

In a preferred embodiment, the additional collecting device further comprises

an additional compressor for compressing the gaseous helium collected by the additional collecting device, and

an additional compressed gas storage tank for compressed helium. Using the additional compressor and the additional compressed gas storage tank, the helium collected by the additional collecting device can be stored quickly and in a space-saving manner. If necessary, the filling of the application cryostat with liquid helium can be briefly interrupted in order to empty a full flexible container using the additional compressor and thus free up volume for further, evaporated helium. As a result, the volume VOLB of the flexible container can be reduced. The additional compressed gas storage tank is typically a high-pressure storage tank designed for a gas pressure of up to at least 180 bar, preferably up to at least 300 bar.

Alternatively, it is also possible to re-liquefy gaseous helium collected by the flexible container directly using the liquefaction device and to store the liquefied helium in the intermediate storage tank (or also in an auxiliary storage tank). However, this is more time-consuming than the storage in the additional compressed gas storage tank, since the compression in the additional compressed gas storage tank typically takes place faster than the liquefaction of the same quantity of helium.

In a preferred development of this embodiment, the additional compressor is dimensioned such that it can store the container volume VOLB completely filled with gaseous helium at normal pressure in the additional compressed gas storage tank within 4 hours or less, preferably within 2 hours or less. This makes it possible to start removing the mobile liquefaction plant quickly after filling the (last) application cryostat at an application site if the mobile liquefaction plant is not to be transported together with the filled flexible container.

One embodiment in which the intermediate storage tank is separable from the remainder of the mobile liquefaction plant and transportable separately is advantageous. As a result, it is possible to bring the intermediate storage tank close to the application cryostat when the latter is to be filled with the liquefied helium from the intermediate storage tank. The remainder of the mobile liquefaction plant usually remains outside the building in which the application cryostat is set up at the application site.

One embodiment in which the mobile liquefaction plant is arranged on a truck or on a roadworthy trailer for a motor vehicle is also advantageous. As a result, the mobile liquefaction plant is transportable easily and quickly. A truck or a trailer can usually be driven close to a building in which the stationary application plant is accommodated at an application site.

Also advantageous is an embodiment in which the mobile liquefaction plant is arranged on a transport frame, in particular within an ISO container, which is designed to be mounted onto and dismounted from a truck or a roadworthy trailer for a motor vehicle. The mobile liquefaction plant can then be unloaded easily and quickly from the truck or trailer at the application site via the transport frame. Once the regeneration of the local application plant is completed, the mobile liquefaction plant can be reloaded easily and quickly onto the truck or trailer. As a result, the truck or trailer does not have to remain on site during the regeneration but can be used at other application sites.

Exemplary Systems Including the Mobile Plant

The scope of the present invention also includes a system for recovering and liquefying evaporated helium, comprising

a large number of application plants at respective, spatially separated, stationary application sites, and

a mobile liquefaction plant according to the invention, as described above,

wherein the application plants at the stationary application sites each comprise

at least one application cryostat containing liquid helium, and

a collecting device for collecting gaseous helium evaporating from the at least one application cryostat,

wherein the collecting device comprises a compressor for compressing the gaseous helium collected by the collecting device and a compressed gas storage tank for compressed helium. Within the scope of the invention, the mobile liquefaction plant can be used to regenerate the application plants at a large number of application sites in a simple, space-saving and cost-effective manner at the application sites. The different application sites are typically several kilometers apart, e.g., at least 5 km apart. Each application plant, or specifically its collecting device, has a compressor and a compressed gas storage tank in order to be able to store large quantities of evaporated helium gas, so that regenerations are only necessary occasionally.

It must be noted that the local collecting device can have a local collecting container with a flexible wall (“flexible collecting container”) for the intermediate storage (buffering) of evaporated helium that is connected upstream of the compressor and the compressed gas storage tank. Alternatively, the compressor (usually a medium-pressure compressor and usually with speed control, in particular for keeping the pressure at the outlet of the application cryostat constant) can compress evaporated helium directly and continuously into the compressed gas storage tank (usually a medium-pressure compressed gas storage tank). Further alternatively, a pre-compressor (usually a medium-pressure pre-compressor and usually with speed control, in particular for keeping the pressure at the outlet of the application cryostat constant) of the collecting device can directly and continuously store evaporated helium in a pre-compressed gas storage tank (usually a medium-pressure pre-compressed gas storage tank) of the collecting device, wherein the compressor (usually a high-pressure compressor) and the compressed gas storage tank (usually a high-pressure compressed gas storage tank) are connected downstream of the pre-compressor and the pre-compressed gas storage tank, and wherein the compressor is only activated occasionally in order to empty the pre-compressed gas storage tank and compress its helium into the compressed gas storage tank.

The application plants or the collecting devices at the application sites are preferably each designed such that a constant pressure is set at an outlet of the consumer/application cryostat, in particular this constant pressure being above atmospheric pressure; this can be set up as a buffering gas collecting device via a pressure control device or a balloon storage device (flexible collecting container). For the compressor or pre-compressor for compressing the evaporated helium gas, a safety device is preferably provided which ensures that the suction pressure of the compressor is not applied directly to the application cryostat. In particular, the safety device can be designed such that it switches off the compressor when the balloon storage device (flexible collecting container) is empty or when the suction pressure falls below a specific threshold value. A bypass can also be provided from the compressed gas storage tank (for example, a high-pressure compressed gas storage tank) to the compressor suction side, which ensures that the suction-side pressure can never become too low.

The application cryostat can in particular be part of an NMR magnet.

Typically, the collecting devices of the application cryostat(s) are only designed to collect the helium evaporating during normal operation (steady state operation) of the application cryostat(s), for example, for an He gas flow that corresponds to the equivalent of 0.2 l (liquid)/h or less, usually 0.1 l (liquid)/h or less, and are in particular not designed to collect the gaseous helium which evaporates when the application cryostat is filled with liquid helium. If the collecting devices have a local flexible collecting container for gaseous helium with a flexible wall for the intermediate storage (buffering) of gaseous helium approximately under atmospheric pressure, it is typically provided with a small storage volume VOLS of, for example, 2000 liters or less, usually 1000 liters or less, or also 200 liters or less. In particular, VOLB≥5*VOLS usually applies, and frequently also VOLB≥10*VOLS.

The compressed gas storage tank is typically a high-pressure storage tank designed for a gas pressure of up to at least 180 bar, preferably up to at least 300 bar.

In an advantageous embodiment of the system according to the invention, the collecting device of each application plant is designed such that

a) gaseous helium evaporating from the at least one application cryostat is fed directly to the compressor, or
b) gaseous helium evaporating from the at least one application cryostat is fed directly to a pre-compressor which pre-compresses the gaseous helium and stores it in a pre-compressed gas storage tank, and the compressor and the compressed gas storage tank are connected downstream of the pre-compressor and the pre-compressed gas storage tank, or
c) gaseous helium evaporating from the at least one application cryostat is fed to a local collecting container with a flexible wall in which the collected gaseous helium can be stored approximately at atmospheric pressure, the local collecting container with a flexible wall having an available container volume VOLS of a maximum of 2 m³, preferably of a maximum of 1 m³, particularly preferably of a maximum of 200 liters. In this embodiment, the application plants or the respective collecting devices have a particularly simple and space-saving structure. Each collecting device is adequately designed for collecting evaporating helium resulting from normal operation (e.g., up to a maximum of 0.2 l/h in the liquid state); the collecting device is not designed for large quantities of gaseous helium accumulating in a short time (as are released when the application cryostat is filled with liquid helium), which is very cost-effective and saves space. For collecting the large quantity of gaseous helium released in a short time when the application cryostat is filled with liquid helium, the mobile liquefaction plant is provided with its additional collecting device.

In a preferred embodiment of the system according to the invention, the compressed gas storage tank is separable from the remainder of the application plant and transportable separately. As a result, the compressed gas storage tank can be brought close to the cleaning device and the liquefaction device of the mobile liquefaction plant (which is usually placed in front of a building in which the application plant is arranged) when the gas from the compressed gas storage tank is supposed to be liquefied. As a result, long gas lines in buildings can be avoided.

In addition, one embodiment is preferred in which the application plants each further comprise

a remotely readable monitoring device for monitoring an accumulated helium quantity collected by the collecting device of each application plant and/or for monitoring the filling level of liquid helium in the at least one application cryostat of the application plant. The accumulated helium quantity can be measured, for example, by the pressure in the compressed gas storage tank (if the compressed gas storage tank volume is known). A “need for regeneration” (i.e., a need for reliquefaction of the accumulated helium and its return to the application cryostat) can be detected by the monitoring device. In addition, a helium leak or an air intake can be detected, for example, in the case of a disparity between the change in filling level in the application cryostat and the accumulating helium quantity collected.

Exemplary Uses of the System

The scope of the present invention also includes the use of a system according to the invention, as described above, for recovering and liquefying evaporated helium,

wherein the mobile liquefaction plant is moved by a motor vehicle, in particular by a truck, between the respective, spatially separated, stationary application sites of the large number of application plants,
and wherein, at each application site, gaseous helium collected by the collecting device of each application plant via the mobile liquefaction plant

is depleted of non-helium components by the cleaning device,

is liquefied by the liquefaction device and collected in the intermediate storage tank, and

is filled from the intermediate storage tank into the at least one application cryostat,

wherein the gaseous helium evaporating during the filling of at least one application cryostat with liquid helium is collected by the additional collecting device of the mobile liquefaction plant. Within the scope of the invention, the same mobile liquefaction plant is used to successively reliquefy the evaporated helium that has accumulated over time at different application sites. This is simple and space-saving and cost-effective at each application site. The mobile liquefaction plant is typically transported via the road network, for example, by a truck or by a roadworthy trailer of a motor vehicle. Typically, the mobile liquefaction plant remains at one application site for a maximum of 15 days, usually for a maximum of 8 days at one application site, before it is moved to the next application site. In the case of particularly powerful mobile liquefaction plants or application plants with only a small helium inventory, the mobile liquefaction plant usually only remains at one application site for 1 to 2 days.

In a preferred variant of the use according to the invention in connection with a mobile liquefaction plant with a temperature control device and a transfer line, the gaseous helium evaporating when the at least one application cryostat is filled with liquid helium is first fed to the temperature control device which is transported separately from the remainder of the mobile liquefaction plant to the application cryostat and connected to the application cryostat, and the gaseous helium heated by the temperature control device is guided by the transfer line to the additional collecting device. The temperature control device ensures that little or no condensation or ice is formed on the transfer line, thus preventing the formation of accident-prone puddles, in particular in buildings.

In one preferred embodiment, an additional quantity of helium is brought to each application site by the mobile liquefaction plant, and, when the at least one application cryostat is filled at the application site, this additional quantity of helium is filled in liquefied form into the at least one application cryostat in addition to the helium obtained from the collecting device of the application plant at the application site. As a result, in particular (uncollected) losses of helium during operation of the application plant can be compensated for in a simple manner.

In a preferred development of this variant, the helium quantity evaporating when the at least one application cryostat is filled at this application site and collected by the additional collecting device is removed from the application site using the mobile liquefaction plant, the additionally added additional quantity of helium and the helium quantity collected by the additional collecting device being approximately the same. This ensures that the application plant retains approximately the helium quantity present before the regeneration, without the need to “return” the collected helium to the application plant after the application cryostat has been filled with liquid helium (during which the mobile liquefaction plant collects the evaporating helium). This means that regeneration can take place particularly quickly. Typically, the additional quantity and the helium quantity collected by the additional collecting device differ by a maximum of 20%, based on the additional quantity. The additional quantity can be somewhat greater than the helium quantity collected in order to compensate for remaining (non-recoverable) helium losses from the operation of the application cryostat.

Also preferred is a variant in connection with a mobile liquefaction plant with an additional compressor and an additional compressed gas storage tank in which the gaseous helium collected by the additional collecting device is compressed by the additional compressor and stored in the additional compressed gas storage tank. As a result, a smaller volume VOLB of the flexible container is usually sufficient, and larger quantities of helium can also be handled or transported comparatively safely using the mobile liquefaction plant.

Advantageously, in a variant in connection with a mobile liquefaction plant with an additional compressor and an additional compressed gas storage tank, helium is kept available in the mobile liquefaction plant while the mobile liquefaction plant is transported from one application site to another application site, this helium being present exclusively in the additional compressed gas storage tank but not in liquid form in the remainder of the mobile liquefaction plant. As a result, the transport of the mobile liquefaction plant becomes safer and losses from evaporating helium during transport are minimized.

A variant in connection with a mobile liquefaction plant with an additional compressor and an additional compressed gas storage tank in which helium from the additional compressed gas storage tank is liquefied by the liquefaction device and collected in the intermediate storage tank or an auxiliary storage tank of the mobile liquefaction plant while the mobile liquefaction plant is moved from one application site to another application site is advantageous. As a result, the operational readiness of the mobile liquefaction plant can be improved, or the time of transport can be utilized. In this case, the mobile liquefaction plant is typically supplied with operating current from the on-board network of a truck or a motor vehicle by which the mobile liquefaction plant is transported or is supplied from its own energy source.

In a preferred variant of the use according to the invention in connection with a mobile liquefaction plant with a separable intermediate storage tank at each application site, after liquefaction of the gaseous helium collected by the collecting device of each application plant by the liquefaction device and collecting the liquefied helium in the intermediate storage tank, the intermediate storage tank is separated from the remainder of the mobile liquefaction plant and transported to the at least one application cryostat and connected to the at least one application cryostat. As a result, cold hose lines from the mobile liquefaction plant to the application cryostat can be prevented or minimized. For its separate transport, the intermediate storage tank can be equipped with rollers or it can be transported by a lift truck.

Also advantageous is a variant in connection with a system with separable compressed gas storage tanks of the application plants in which, at each application site, the compressed gas storage tank is separated from the remainder of the application plant and transported to the mobile liquefaction plant and connected to the mobile liquefaction plant prior to the start of the depletion of non-helium components from the helium collected by the collecting device of each application plant. As a result, long gas lines from the collecting device to the mobile liquefaction plant can be avoided or minimized. In particular, the compressed gas storage tank can be transported by a lift truck.

In addition, a variant in connection with a system with a remotely readable monitoring device at the application plants in which the mobile liquefaction plant is brought to an application plant at an application site if it is determined by the local remotely readable monitoring device that the accumulated helium quantity collected by the collecting device of the local application plant exceeds a first limit value and/or the filling level of liquid helium in the at least one application cryostat of the local application plant falls below a second limit value is preferred. As a result, the mobile liquefaction plant can be used in a targeted manner according to the regeneration requirements of the application plants.

Further advantages of the invention can be found in the descriptions and the drawings. According to the invention, the features mentioned above and set out in the following can also each be used individually per se or together in any combination. The embodiments shown and described are not to be understood as an exhaustive list but instead are of an exemplary nature for describing the invention.

### BRIEF DESCRIPTION OF THE DRAWINGS

FIG. 1 shows, by way of example, a schematic overview of a system according to the invention for recovering and liquefying helium;

FIG. 2 schematically shows, by way of example, a stationary application plant and a mobile liquefaction plant during the liquefaction of helium from a stationary compressed gas storage tank to the local collecting device for the invention;

FIG. 3 schematically shows, by way of example, a stationary application plant and a mobile liquefaction plant during the liquefaction of helium from a separate compressed gas storage tank to the local collecting device for the invention;

FIG. 4 schematically shows, by way of example, a stationary application plant and a mobile liquefaction plant during the filling of a local application cryostat of the stationary application plant with liquid helium with a separate intermediate storage tank of the mobile liquefaction plant for the invention;

FIG. 5 schematically shows, by way of example, a stationary application plant and a mobile liquefaction plant during the filling of a local application cryostat of the stationary application plant with liquid helium with a separate intermediate storage tank of the mobile liquefaction plant, and with a temperature control device for gaseous helium collected by the additional collecting device of the mobile liquefaction plant for the invention;

FIG. 6 schematically shows, by way of example, an alternative design of a stationary application plant for the invention.

### DETAILED DESCRIPTION

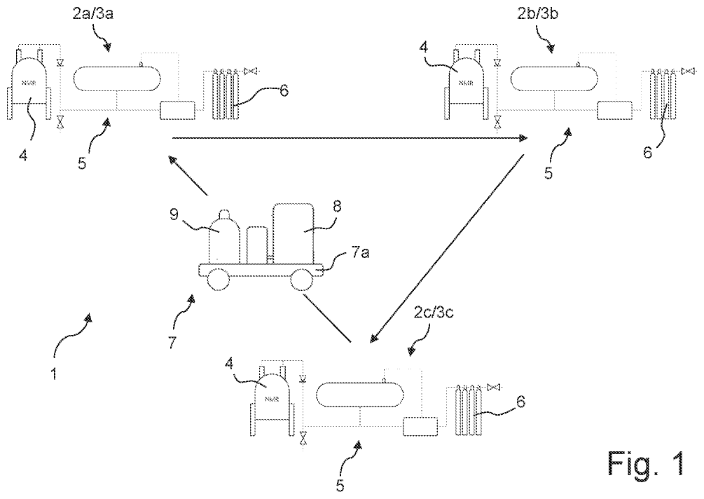

FIG. 1 is a schematic view of an exemplary system 1 according to the invention for recovering and liquefying helium.

The system 1 comprises plural stationary application plants 3a, 3b, 3c located at a number of respective application sites 2a, 2b, 2c, wherein three application sites 2a-2c are illustrated herein by way of example. Each application plant 3a, 3b, 3c comprises at least one application cryostat 4 and a collecting device 5 for collecting gaseous helium evaporating from the application cryostat 4. Each collecting device 5 comprises at least one compressed gas storage tank 6 in which the evaporated helium is stored locally.

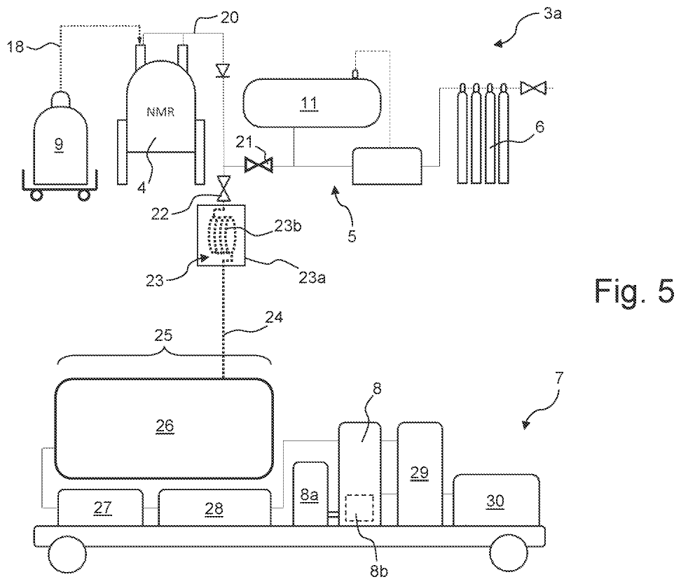

The system 1 further comprises a mobile liquefaction plant 7. The mobile liquefaction plant 7 comprises at least one liquefaction device 8 for liquefying gaseous or supercritical helium, an upstream cleaning device for helium (not shown in FIG. 1-4, but cf. FIG. 5 for this), an intermediate storage tank 9 for liquefied helium, and an additional collecting device for collecting gaseous helium, including a container with a flexible wall (not shown in FIG. 1-4, but cf. FIG. 5 for this).

The mobile liquefaction plant 7 is moved to the different application sites 2a-2c in chronological order, for example, cyclically. For this purpose, the mobile liquefaction plant 7 can be arranged on a truck (not shown in detail) or, as also shown herein, on a roadworthy trailer 7a which is pulled by a motor vehicle (not shown). If the mobile liquefaction plant 7 is to be lifted off the trailer 7a at one or more of the application sites 2a-2c, the mobile liquefaction plant 7 can form a transport frame for mounting on and dismounting from the trailer 7a. The mobile liquefaction plant 7 remains at each application site 2a-2c for a specific period of time, usually between 1 to 2 days or even up to 8 days and in some cases also up to 15 days, in order to liquefy the helium accumulated in the local compressed gas storage tank 6 and refill the application cryostat(s) 4 of the stationary application plant 3a-3c (“regeneration”). After completion of each regeneration, the mobile liquefaction plant 7 moves to the next application site 2a-2c in order to regenerate the local application plant 3a-3c.

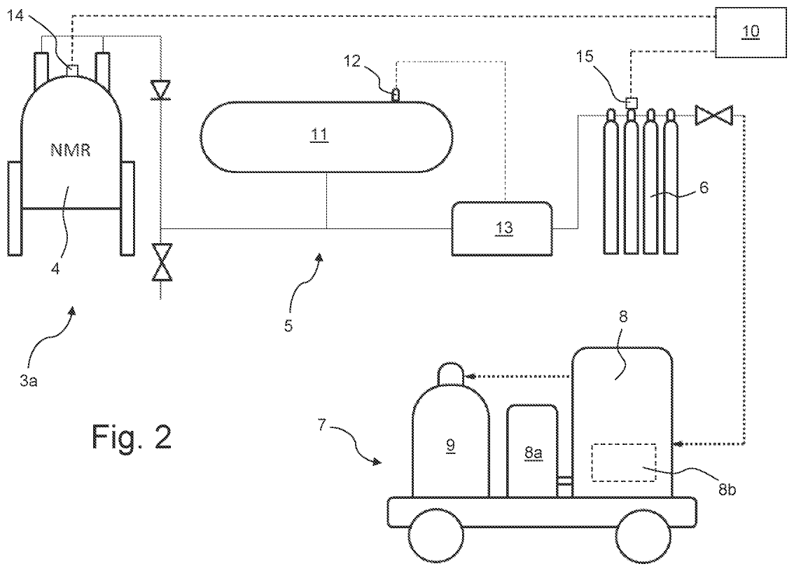

When a mobile liquefaction plant 7 has arrived at an application site, the local compressed gas storage tank 6, as shown in FIG. 2, is connected to the mobile liquefaction plant 7 in order to liquefy the helium collected in the compressed gas storage tank 6. The mobile liquefaction plant 7 usually stops in front of a building in which the stationary application plant 3a is arranged, and a gas line (hose line) is laid from the compressed gas storage tank 6 through the building to the mobile liquefaction plant 7. The helium arriving from the compressed gas storage tank 6 first passes through the cleaning device (not shown in detail) in the mobile liquefaction plant 7 and then arrives at the liquefaction device 8 in which the helium is liquefied. The mobile liquefaction plant 7 has its own liquefier compressor 8a with which, depending on the design, a cryocooler of the liquefaction device 8 can be operated, or the helium to be liquefied can also be compressed. The liquefier compressor 8a is preferably air-cooled, but it can also be water-cooled. The liquefied helium is collected in the intermediate storage tank 9 which is typically designed as a Dewar vessel. It must be noted that an auxiliary storage tank 8b can be integrated into the liquefier device 8, in which liquid helium can also be collected (for later transfer to the intermediate storage tank 9 especially if the intermediate storage tank 9 is designed, as in this case, to be separable).

FIG. 2 also shows an exemplary design of a stationary application plant 3a for the invention, which, in this case, comprises an application cryostat 4 (herein a superconducting NMR magnet), a collecting device 5 for helium and a remotely readable monitoring device 10.

In this case, the collecting device 5 has a local collecting container 11 with a flexible wall in which the helium evaporated from the application cryostat 4 can be stored under atmospheric pressure (approximately 1 bar). The maximum collecting volume VOLS of the local collecting container 11 is relatively small, usually 200 liters or less, because it only has to be used to collect the evaporating helium during normal operation. A volume sensor 12 is used to determine when the collecting container 11 is (almost) full, whereupon a compressor 13 (here a high-pressure compressor) is activated which compresses the helium located in the collecting container 11 into the compressed gas storage tank 6 (here a high-pressure compressed gas storage tank with a maximum pressure of, e.g., 200 bar). Depending on the maximum collecting volume VOLS of the collecting container 11 and the evaporation rate of the application cryostat(s) 4, the compressor 13 is usually activated 1-2 times a day or 1-3 times a week.

With the remotely readable monitoring device 10, a fill level sensor 14 on the application cryostat 4 is read out which measures the level of liquid helium in the application cryostat 4, and a pressure sensor 15 on the compressed gas storage tank 6 is also read out. The measurement results can be transmitted to the dispatcher of the mobile liquefaction plant 7 who sends the mobile liquefaction plant 7 to the application plant 3a for a regeneration of this application plant 3a if the filling level in the application cryostat 4 becomes too low and/or the gas pressure in the compressed gas storage tank 6 becomes too high.

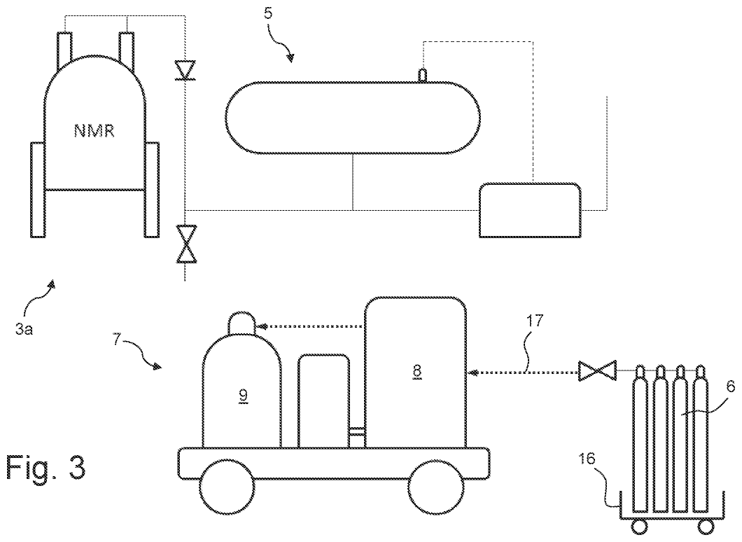

In order to reduce the effort involved in laying gas lines during regeneration, the compressed gas storage tank 6 is designed such that it is separable from the collecting device 5 of the stationary application plant 3a and transportable, as shown in FIG. 3. In the variant shown, the compressed gas storage tank 6 has a rolling base 16 with which the compressed gas storage tank 6 can be brought from the collecting device 5 close to the mobile liquefaction plant 7, in particular by being pushed manually. As a result, only a very short gas line 17 is necessary in order to fill the liquefaction device 8 with the helium to be liquefied.

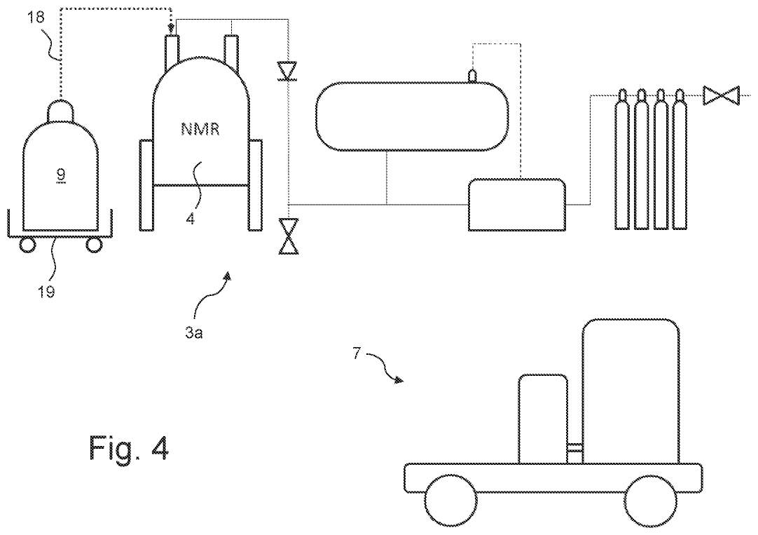

After the helium from the compressed gas storage tank 6 has been cleaned and liquefied by the mobile liquefaction plant 7 and the liquid helium has been temporarily stored in the intermediate storage tank 9, the liquid helium is now returned to the application cryostat 4 of the stationary application plant 3a, as illustrated in FIG. 4. In order to avoid long cold hose lines for cryogenic liquid helium, the intermediate storage tank 9 can be separated from the mobile liquefaction plant 7 and brought close to the application cryostat 4. In the variant shown, the intermediate storage tank 9 has a rolling base 19 on which the intermediate storage tank 9 can easily be pushed manually. The intermediate storage tank 9 is connected to the application cryostat 4 with a short, usually vacuum-insulated transfer line 18.

FIG. 5 shows the structure of the stationary application plant 3a and the mobile liquefaction plant 7 for replenishing the liquid helium at the application cryostat 4 in somewhat more detail.

While liquid helium is filled back into the application cryostat 4 from the intermediate storage tank 9, the heat input into the liquid helium results in the evaporation of helium at least at the transfer line 18, i.e., in the formation of a large quantity of gaseous helium which accumulates at an outlet 20 of the application cryostat 4. Since this quantity of gaseous helium is too large for the stationary flexible collecting container 11 of the collecting device 5, this gaseous helium is collected by the mobile liquefaction plant 7.

For this purpose, the shut-off valve 21 to the collecting device 5 is closed, and the shut-off valve 22 connected to the mobile liquefaction plant 7 is opened. A temperature control device 23 is connected directly behind the shut-off valve 22, with which the evaporating cold helium gas is heated to approximately room temperature.

In this case, the temperature control device 23 is formed with a water tank 23a which is filled with water (usually tap water) at room temperature. A tube coil 23b in which the helium gas is conducted passes through the water tank 23a, heating the helium gas on the inner wall of the tube coil 23b. As a result, the transfer line 24 for the helium gas (preferably a lay-flat hose) connected behind the temperature control device 23 remains approximately at room temperature, so that little or no condensation and also no ice forms on this transfer line 24. The temperature control device 23 and the transfer line 24 are part of the mobile liquefaction plant 7, wherein the temperature control device is transportable separately in a manner not shown in detail, for example, by rollers.

The transfer line 24 leads to an additional collecting device 25 for gaseous helium of the mobile liquefaction plant 7. It has a container 26 with a flexible wall (“flexible container”) which has a maximum collecting volume VOLB of at least 5 m³, and usually at least 15 m³. In this container 26, the gaseous helium released when the liquid helium is filled at the application cryostat 4 can be collected approximately at atmospheric pressure, in particular also in a larger quantity. The additional collecting device 25 also has an additional compressor 27 (here a high-pressure additional compressor) and an additional compressed gas storage tank 28 (here a high-pressure compressed gas storage tank) with which collected gaseous helium can be compressed in the mobile liquefaction plant 7 and stored in a space-saving manner. Helium from the additional compressed gas storage tank 28 can be cleaned in the cleaning device 29 and liquefied in the liquefaction device 8 and stored in an integrated auxiliary storage tank 8b or in the intermediate storage tank 9 (as soon as the intermediate storage tank 9 is arranged again on the mobile liquefaction plant 7, not shown in FIG. 5, but cf., for example, FIG. 2).

The additional compressed gas storage tank 28 can be used to bring an additional quantity of helium to a stationary application plant 3a with the mobile liquefaction plant 7 in a simple and comparatively safe and low-loss manner. The additional quantity of helium contained in the additional pressure storage tank 28 can be liquefied together with the locally collected helium from the local pressure storage tank 6 in the liquefaction device 8 and subsequently also filled into the application cryostat 4. As a result, helium losses during operation can be compensated (these losses are usually low). However, the additional quantity of helium brought along can most notably be used to compensate for the quantity of gaseous helium which is collected by the additional collecting device and evaporates when the liquid helium is filled into the application cryostat 4 and collected by the mobile liquefaction plant 7. Accordingly, it is no longer necessary to return this collected helium to the operator of the application plant 3a, so that the regeneration can be carried out particularly quickly and in a fair manner with regard to the helium quantity.

In the design shown, the mobile liquefaction plant 7 also has its own power supply 30 (for example, a fuel-operated generator) with which the cleaning device 29, the liquefaction device 8 including the liquefier compressor 8a, the additional compressor 27, and the additional compressed gas storage tank 28 can be operated in a self-sufficient manner, in particular also during a transport of the mobile liquefaction plant 7.

The cleaning device 29 typically has a cryogenic surface that is cooled to a cryogenic temperature below 100 K, usually around 30-80 K (“nitrogen trap”) and which can be enlarged in particular with activated carbon. In the cleaning device 29, contaminants are sorbed and/or frozen out, making it possible to obtain a highly pure helium, usually with a purity of 99.99% or better. The cleaning device 29 preferably has two cleaning units which are connected in parallel, so that one cleaning unit can be baked out, as a result of which sorbed and/or frozen out contaminants can be removed from the cleaning unit without having to interrupt the cleaning operation (not shown in detail).

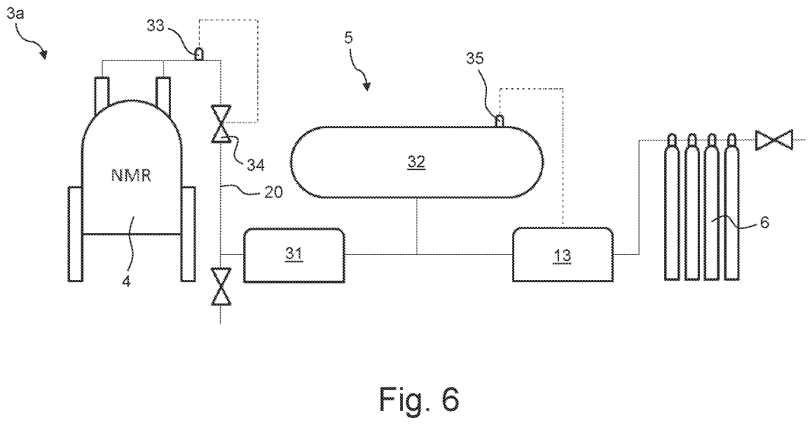

FIG. 6 shows another design of a stationary application plant 3a for the invention in which the collecting device 5 is formed with a pre-compressor 31, here a medium-pressure pre-compressor, and a pre-compressed gas storage tank 32, here a medium-pressure pre-compressed gas storage tank. The pre-compressor 31 is connected directly to the outlet 20 of the application cryostat 4. Using the pre-compressor 31, evaporated helium can be compressed during normal operation and conveyed into the pre-compressed gas storage tank 32. In order to ensure that the suction pressure of the pre-compressor 31 is not applied to the application cryostat 4, a pressure sensor 33 is provided in the gas line from the application cryostat 4, and when a negative pressure (pressure less than 1 bar) is detected at the pressure sensor 33, a subsequent shut-off valve 34 is automatically closed.

The medium-pressure pre-compressed gas storage tank and the medium-pressure pre-compressor are typically dimensioned for a maximum pressure of 25 bar or less, or also for a maximum pressure of 15 bar or less, and frequently for a maximum pressure between 8 and 12 bar. As soon as the maximum pressure (or a slightly lower, provided limit pressure) is reached in the pre-compressed gas storage tank 32, which can be determined by the pressure sensor 35, the compressor 13 is activated and the helium contained in the pre-compressed gas storage tank 32 is conveyed by the compressor 13 (high-pressure compressor) into the compressed gas storage tank 6 (high-pressure compressed gas storage tank).

It must be noted that, in a further embodiment, the outlet 20 of the application cryostat 4 can also be placed in one stage on the compressor 13, without a pre-compressor and pre-compressed gas storage tank.

### LIST OF REFERENCE SIGNS

1 System
2a-2c Application site
3a-3c Stationary application plant
4 Application cryostat
5 Collecting device
6 Compressed gas storage tank
7 Mobile liquefaction plant
7a Trailer
8 Liquefaction device
8a Liquefier compressor
8b Auxiliary storage tank
9 Intermediate storage tank
10 Remotely readable monitoring device
11 Local collecting container with a flexible wall
12 Volume sensor
13 Compressor
14 Filling level sensor
15 Pressure sensor
16 Trolley
17 Gas line
18 Transfer line
19 Trolley
20 Outlet
21 Shut-off valve
22 Shut-off valve
23 Temperature control device
23a Water tank
23b Tube coil
24 Transfer line
25 Additional collecting device
26 Container with a flexible wall (flexible container)
27 Additional compressor
28 Additional compressed gas storage tank
29 Cleaning device
30 Own power supply (power generator)
31 Pre-compressor
32 Pre-compressed gas storage tank
33 Pressure sensor
34 Shut-off valve
35 Pressure sensor

What is claimed is:

1. Mobile liquefaction plant for liquefying helium, comprising
a liquefaction device configured to liquefy the helium,
an intermediate storage tank configured to store the liquefied helium,
a cleaning device configured to remove non-helium components from the helium by freezing out and/or sorption at a cryogenic temperature of ≤100 K and connected upstream of the liquefaction device,
an additional collecting device configured to collect gaseous helium which evaporates when an application cryostat is filled with liquid helium,
wherein the additional collecting device comprises a container with a flexible wall in which the collected gaseous helium is stored at least approximately at atmospheric pressure,
wherein the container with the flexible wall has an available container volume of at least 5 m³, preferably at least 7.5 m³, particularly preferably at least 10 m³, very particularly preferably at least 15 m³,
and wherein the mobile liquefaction plant is arranged on a transport frame that mounts onto and dismounts from a truck or a roadworthy trailer of a motor vehicle.

2. Mobile liquefaction plant according to claim 1, further comprising
a temperature control device configured to heat gaseous helium evaporating from an application cryostat to at least 10° C., preferably to room temperature,
the temperature control device configured to be transported separately from a remainder of the mobile liquefaction plant, and
a transfer line interconnected to transfer heated gaseous helium from the temperature control device to the additional collecting device.

3. Mobile liquefaction plant according to claim 2, wherein the temperature control device is configured as a water tank through which a tube coil, through which the gaseous helium to be heated is conducted, passes.

4. Mobile liquefaction plant according to claim 1, wherein the additional collecting device further comprises
an additional compressor configured to compress the gaseous helium collected by the additional collecting device, and
an additional compressed gas storage tank configured to store the compressed helium.

5. Mobile liquefaction plant according to claim 4, wherein the additional compressor is dimensioned to store the available container volume completely filled with the gaseous helium at normal pressure in the additional compressed gas storage tank within 4 hours or less, preferably within 2 hours or less.

6. Mobile liquefaction plant according to claim 1, wherein the intermediate storage tank is configured to separate from a remainder of the mobile liquefaction plant and to be transported separately from the remainder of the mobile liquefaction plant.

7. Mobile liquefaction plant according to claim 1, wherein the mobile liquefaction plant is arranged on the transport frame within an ISO container that mounts onto and dismounts from the truck or the roadworthy trailer of the motor vehicle.

8. System for recovering and liquefying evaporated helium, comprising
a plurality of application plants located at respective, spatially separated, stationary application sites, and
a mobile liquefaction plant for liquefying helium, comprising
a liquefaction device configured to liquefy the helium,
an intermediate storage tank configured to store the liquefied helium, and
a cleaning device configured to remove non-helium components from the helium by freezing out and/or sorption at a cryogenic temperature of ≤100 K and connected upstream of the liquefaction device,
an additional collecting device configured to collect gaseous helium which evaporates when an application cryostat is filled with liquid helium,
wherein the additional collecting device comprises a container with a flexible wall in which the collected gaseous helium is stored at least approximately at atmospheric pressure,
wherein the container with the flexible wall has an available container volume of at least 5 m³, preferably at least 7.5 m³, particularly preferably at least 10 m³, very particularly preferably at least 15 m³,
and wherein the application plants at the stationary application sites each comprise
at least one application cryostat containing liquid helium, and
a collecting device configured to collect gaseous helium evaporating from the at least one application cryostat,
wherein the collecting device comprises a compressor configured to compress the gaseous helium collected by the collecting device and a compressed gas storage tank configured to store the compressed helium.

9. System according to claim 8, wherein the collecting device of each application plant is configured such that
a) gaseous helium evaporating from the at least one application cryostat is fed directly to the compressor, or
b) gaseous helium evaporating from the at least one application cryostat is fed directly to a pre-compressor which pre-compresses the gaseous helium and stores the pre-compressed helium in a pre-compressed gas storage tank, and the compressor and the compressed gas storage tank are connected downstream of the pre-compressor and the pre-compressed gas storage tank, or
c) gaseous helium evaporating from the at least one application cryostat is fed to a local collecting container with a flexible wall in which the collected, gaseous helium is stored at least approximately at atmospheric pressure, the local collecting container with a flexible wall having an available container volume of a maximum of 2 m³, preferably of a maximum of 1 m³, particularly preferably of a maximum of 200 liters.

10. System according to claim 8, wherein the compressed gas storage tank is configured to separate from a remainder of the application plant and to be transported separately.

11. System according to claim 8, wherein the application plants each further comprise
a remotely readable monitoring device configured to monitor an accumulated helium quantity collected by the respective collecting device of each application plant and/or to monitor a filling level of the liquid helium in the at least one application cryostat of the application plant.

12. Use of a system for recovering and liquefying evaporated helium according to claim 9,
wherein the mobile liquefaction plant is moved by a motor vehicle, in particular by a truck, between the respective, spatially separated, stationary application sites of the plurality of application plants,
and wherein, at each respective application site, gaseous helium collected by the collecting device of each respective application plant by the mobile liquefaction plant
is depleted of non-helium components by the cleaning device,
is liquefied by the liquefaction device and collected in the intermediate storage tank, and
is filled from the intermediate storage tank into the at least one application cryostat,
wherein the gaseous helium evaporating during the filling of at least one application cryostat with liquid helium is collected by the additional collecting device of the mobile liquefaction plant.

13. Use according to claim 12,
wherein an additional quantity of helium is brought to each application site by the mobile liquefaction system,
and wherein, when the at least one application cryostat is filled at the application site, this additional quantity of helium is filled in liquefied form into the at least one application cryostat in addition to the helium obtained from the collecting device of the application plant at the application site.

14. Use according to claim 13,
wherein the helium quantity evaporating when the at least one application cryostat is filled at this application site and collected by the additional collecting device is removed from the application site using the mobile liquefaction plant,
the additionally added additional quantity of helium and the helium quantity collected by the additional collecting device being at least approximately equal to one another.
